(19) United States
(12) Patent Application Publication
(10) Pub. No.: US 2009/0108489 A1
(43) Pub. Date: Apr. 30, 2009

(54) FILM STRETCHING AND RELAXING METHOD AND SOLUTION CASTING METHOD

(75) Inventors: Shinichi Nakai, Fujinomiya-shi (JP); Tetsuya Yoshida, Fujinomiya-shi (JP); Toshinao Arai, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/261,783

(22) Filed: Oct. 30, 2008

(30) Foreign Application Priority Data
Oct. 31, 2007 (JP) 2007-283674

(51) Int. Cl. B29D 7/00; B29C 55/02

(52) U.S. Cl. 264/217; 264/288.4

(57) ABSTRACT

In a stretching area of a tenter, a film is stretched in a Z2 direction. The film has a residual solvent level of not less than 0.03 wt. % and not greater than 10 wt. %. Out of the stretching area, the film enters a relaxing area to relax the film at a predetermined relaxation rate Y (%). Surface temperatures Tp, Ts, Th (° C.) and the relaxation rate Y are controlled to satisfy an expression of 6≦{(− 1/12)×Tp}+{(−⅕)×Ts}+{(⅓)×Th}+Y≦18, where Tp is the temperature of the film five seconds before entering the stretching area, Ts is the temperature of the film at the center in a film transfer direction of the stretching area, and Th is the temperature of the film five seconds after departing the stretching area.

### FIELD OF THE INVENTION

The present invention relates to a film stretching and relaxing method, and a solution casting method to produce polymer films, such as cellulose triacetate films used in liquid crystal display devices.

### BACKGROUND OF THE INVENTION

Because of its toughness and its flame-resistant characteristics, a polymer film of cellulose ester, especially a TAC film made of cellulose triacetate (hereinafter, TAC) with an average acetylation degree of 58.0% to 62.0% is used as a support medium for photosensitive films. Because of its excellent optical isotropy, the TAC film is also used as a retardation film in a polarizer of liquid crystal display devices that penetrate the market rapidly in these days.

The TAC film is produced by the solution casting method. Compared to the melt extrusion method and other film-forming methods, the solution casting method can produce films with better optical property. In the solution casting method, polymer solution (dope) is prepared first by dissolving polymer in mixed solvent consisting primary of dichloromethane or methyl acetate. The dope is then casted from a casting die onto a support member, so as to form a cast film on the support member. This cast film is peeled off as a lengthy wet film from the support member when it shows a self-supporting property. The wet film is transferred to a tenter by a transfer section composed of a plurality of rollers. The wet film in the tenter is stretched in the width direction and dried into a film. This film is dried again, and wound into a roll by a winding device.

By stretching the wet film in the width direction, the tenter orients molecule main chains of the wet film in a predetermined direction. This stretching process changes the wet film to a retardation film with a desired retardation value.

Since the wet film in this stretching process is held at both side ends and stretched in the width direction, a stretch rate is sometimes different between the center portion and the edge portions of the wet film. Such difference of the stretch rate induces a so-called bowing phenomenon where the molecule main chains of the wet film are not linearly oriented, but oriented in an arch-like pattern in the width direction. Due to the bowing phenomenon, a film results to have optical axis variation. This faulty retardation film having the optical axis variation may bring the defects, such as display unevenness and optical unevenness, to the liquid crystal display device.

To discourage the optical axis variation due to the bowing phenomenon, there is disclosed a film-forming method which includes a so-called relaxation process to stretch the wet film, after the above stretching process, in the longitudinal direction so as to remove the remaining stress from the wet film (see, for example, Japanese Patent Laid-open Publication No. 2000-309051).

Meanwhile, it is known that the surface temperature of the wet film during the stretch process greatly affects the retardation value and the orientation of the molecule main chains. Therefore, depending on the temperature conditions in the tenter, a desired retardation value cannot be reached, or the molecule main chains of the wet film cannot be oriented linearly, resulting in the optical axis variation of the wet film.

Therefore, only the relaxation process disclosed in the Publication No. 2000-309051 is not enough to produce a high quality retardation film which provides a predetermined retardation value without causing optical axis variation and optical unevenness.

### SUMMARY OF THE INVENTION

In view of the foregoing, an object of the present invention is to provide a film stretching and relaxing method, and a solution casting method to produce a high quality polymer film which provides a predetermined retardation value without causing optical axis variation and optical unevenness.

In order to achieve the above and other objects, a present invention provides a film stretching and relaxing method for stretching and relaxing a cellulose ester film, whose residual solvent level is not less than 0.03 weight percent and not greater than 10 weight percent, in a width direction of the film, with using a tenter having a preheating area, a stretching area and a relaxing area. According to the present invention, the film stretching and relaxing method includes a film stretching and relaxing method according to the present invention includes a maximum temperature controlling step, a first temperature controlling step, a second temperature controlling step, a stretching step, a third temperature controlling step, a relaxing step, and temperature/relaxing rate controlling step. In the maximum temperature controlling step, the maximum temperature Tmax (° C.) of the cellulose ester film is kept at Tg≦Tmax≦190 in the tenter, wherein Tg is a glass transition temperature (° C.) of the cellulose ester film. In the first temperature controlling step, a temperature Tp (° C.) of the cellulose ester film in the preheating area is kept at 100≦Tp≦190. In the second temperature controlling step, a temperature Ts (° C.) of the cellulose ester film at the halfway point in a film transfer direction of the stretching area is kept at Tg≦Ts≦190. In the stretching step, the cellulose ester film in the stretching area is stretched in the width direction at a stretch rate X (%) of 0<X≦100, wherein the stretch rate X is expressed by a formula (L2−L1)/L1, where L1 is a width of the cellulose ester film immediately before stretching, and L2 is a width of the cellulose ester film immediately after stretching. In the third temperature controlling step, a temperature Th (° C.) of the cellulose ester film in the relaxing area is kept at 50≦Th≦190. In the relaxing step, the cellulose ester film in the relaxing area is relaxed at a relaxation rate Y (%) of 0≦Y≦10, wherein the relaxation rate Y is expressed by a formula (L3−L2)/L2, where L3 is a width of the cellulose ester film immediately after relaxing. In the temperature/relaxation rate controlling step, the Tp, Ts, Th and Y is controlled to satisfy an expression of 6≦{(− 1/12)×Tp}+{(−⅕)×Ts}+{(⅓)×Th}+Y≦18.

It is preferred that optical axis variation in the width direction of the cellulose ester film is adjusted within plus/minus 5 degrees to a line perpendicular to a surface of the cellulose ester film.

A solution casting method according to the present invention includes the above film stretching and relaxing method, and produces a cellulose ester film.

According to the present invention, the tenter is well controlled about the various conditions, and enables producing a high quality polymer film which provides a predetermined retardation value without causing optical axis variation and optical unevenness.

### BRIEF DESCRIPTION OF THE DRAWINGS

The above objects and advantages of the present invention will become more apparent from the following detailed description when read in connection with the accompanying drawings, in which:

FIG. 1 is a schematic view of a solution casting apparatus according to the present invention;

FIG. 2 is a side elevation view of a clip tenter;

FIG. 3 is a plan view of the clip tenter;

FIG. 4 is a graph of temperature Tp of a film versus relaxation rate Y;

FIG. 5 is a graph of temperature Ts of the film versus relaxation rate Y;

FIG. 6 is a graph of temperature Th of the film versus relaxation rate Y;

FIG. 7 is a schematic view of a solution casting apparatus having an additional tenter between a cooling chamber and a winding chamber;

FIG. 8 is a schematic view of an off-line stretching apparatus; and

FIG. 9 is a table of results obtained from examples.

### DETAILED DESCRIPTION OF THE PREFERRED EMBODIMENTS

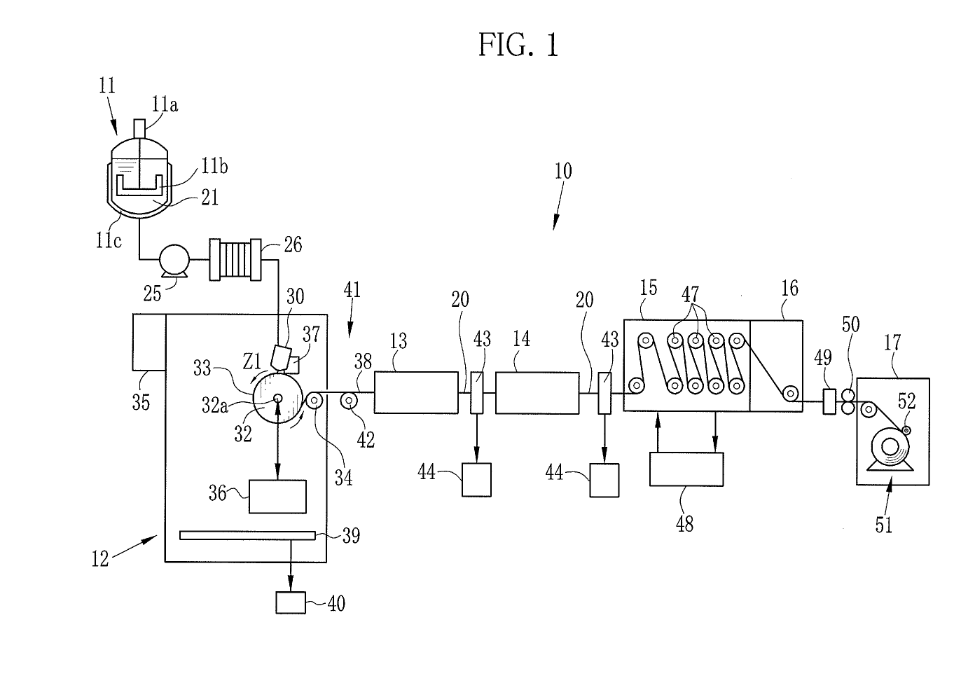

Referring to FIG. 1, a solution casting apparatus 10 includes a stock tank 11, a casting chamber 12, a pin tenter 13, a clip tenter 14, a drying chamber 15, a cooling chamber 16 and a winding chamber 17.

The stock tank 11 has a stirring blade 11b rotated by a motor 11a and a jacket 11c, and contains dope 21 that is a raw material for a film 20. The dope 21 in the stock tank 11 is kept at a substantially constant temperature by the jacket 11c. The dope 21 is kept stirred with the stirring blade 11b, which prevents concentration of polymer and keeps the dope 21 homogeneous. Downstream of the stock tank 11 are disposed a gear pump 25 and a filtering device, through which the dope 21 is transferred to a casting die 30.

The casting chamber 12 encloses the casting die 30, a casting drum 32 as a support member, a peel roller 34, temperature controllers 35, 36 and a decompression chamber 37. The casting drum 32 is rotated in a direction shown with an arrow Z1 by a drive unit (not shown). The dope 21 is casted from the casting die 30 onto this rotating casting drum 32, and a cast film 33 is formed on the surface of the casting drum 32.

The casting chamber 12 and the casting drum 32 are kept, by the temperature controllers 35, 36 respectively, at a temperature for the cast film 33 to be easily cooled to a gel state. As the casting drum 32 makes substantially three-quarter rotation, the cast film 33 reaches the gel strength to support itself (showing a self-supporting property), and is peeled off with the peel roller 34 from the casting drum 32.

The cast film 33 can be peeled off regardless of the residual solvent level, insofar as it is hard enough to transfer. Nonetheless, it is preferred to peel off the cast film 33 from the casting drum 32 when the residual solvent level is high, specifically in the range not less than 150 wt. % and not greater than 320 weight %. When the residual solvent level exceeds 320 wt. %, the cast film 33 is difficult to peel off from the casting drum 32. When the residual solvent level falls below 150 wt. %, on the other hand, the peeled cast film 33 needs to be dried for longer time. In this case, the cast film 33 may result to have a rough surface due to dry air or the like substance sprayed thereto for drying. Peeling off the cast film 33 when the residual solvent level is high will enable the clip tenter 14 to control the orientation of cellulose acylate molecules effectively. A thing to note is that the residual solvent level is calculated on a dry basis by the formula {x/(y−x)}×100, where x represents the weight of the solvent, and y represents the weight of the cast film.

To peel off the cast film 33 while the residual solvent level remains highest possible, the cast film 33 is cooled to a gel state by the casting drum 32. When the self-supporting property has been developed, the cast film 33 is peeled off as a wet film 38 from the casting drum 32, while supported with the peel roller 34. If the wet film 38 is to be produced at a high production speed of not less than 50 m/min, the cast film 33 may be cooled rapidly so that the film can be peeled off with the residual solvent level of not less than 250 weight percent (wt. %). For better production efficiency, it is preferred to supply dry air around the cast film 33, when the exposed surface of the cast film 33 is fully solidified, so as to improve the stability in transfer of the peeled film.

The decompression chamber 37 is placed downstream of the casting die 30 in the Z1 direction. The decompression chamber 37 reduces the atmospheric pressure around the rear side (the side to touch the surface of the casting drum 32) of a casting bead to a predetermined level, and attenuates the influence of carrier wind which is produced by the high speed rotation of the casting drum 32. Owing to the decompression chamber 37, a stable casting bead can be formed between the casting die 30 and the casting drum 32, and the cast film 33 can thereby be formed with little thickness variation.

The casting die 30 is made of the material having an excellent corrosion-resistance property to dichloromethane mixture, methanol mixture or such liquid mixture, as well as having low coefficient of thermal expansion. A dope-contact surface of the casting die 30 is preferably finished with high precision to have a surface roughness of not greater than 1 μm. More preferably, this contact surface has a straightness of not greater than 1 μm/m in either direction.

The casting drum 32 has a chrome-plated surface, offering an adequate corrosion-resistance and strength. The temperature controller 36 circulates heat transfer medium inside the casting drum 32 so as to maintain the surface of the casting drum 32 at a predetermined temperature. The heat transfer medium is kept at a certain temperature, and changes the surface temperature of the casting drum 32 as it passes through a flow channel formed inside the casting drum 32.

The width of the casting drum 32 is preferably, though not limited to, in the range from 1.1 to 2.0 times as wide as dope casting width. A preferable material for the casting drum 32 is stainless, especially SUS316 which offers good corrosion-resistance and strength. The chrome plating on the surface of the casting drum 32 preferably has Vickers hardness Hv of not less than 700 and a thickness of not less 2 μm, such as the one called hard chrome plating.

In the casting chamber 12, a condenser 39 and a recovery device 40 are provided. The condenser 39 condenses and recovers organic solvent vapor in the casting chamber 12. The liquefied organic solvent in the condenser 39 is recovered in the recovery device 40. This recovered solvent is refined with a refining apparatus (not shown), and reused as dope adjusting solvent.

Downstream from the casting chamber 12 are disposed a transfer section 41, the pin tenter 13 and the clip tenter 14 sequentially in this order. The wet film 38, peeled off with a feed roller 42, is transferred by way of the transfer section 41 to the pin tenter 13. The pin tenter 13 is equipped with a pin plate (not shown) which has a plurality of pins to pierce the side ends of the wet film 38, and runs along a track. The wet film 38 is held and conveyed by the pin plate, with dry air applied to the wet film 38. The wet film 38 is thereby dried into a film 20.

In the pin tenter 13, the wet film 38 may preferably be dried to the residual solvent level of not less than 0.1 wt. % and not greater than 10 wt. %. By peeling off the cast film 33 on the residual solvent level of not less than 150 wt. % and not greater than 320 wt. %, and drying the wet film 38 to the aforesaid residual solvent level, the orientation of the cellulose acylate molecules can be controlled more effectively in the clip tenter 14. In other words, these peeling process and drying process enhance the effects of the clip tenter 14 to control a slow axis direction, to increase retardation values (Re and Rth) and to improve optical unevenness. However, the wet film 38 may not be necessarily dried to the above residual solvent level in the pin tenter 13. Namely, it may be possible to feed the wet film 38 with the residual solvent level of more than 10 wt. % in the clip tenter 14.

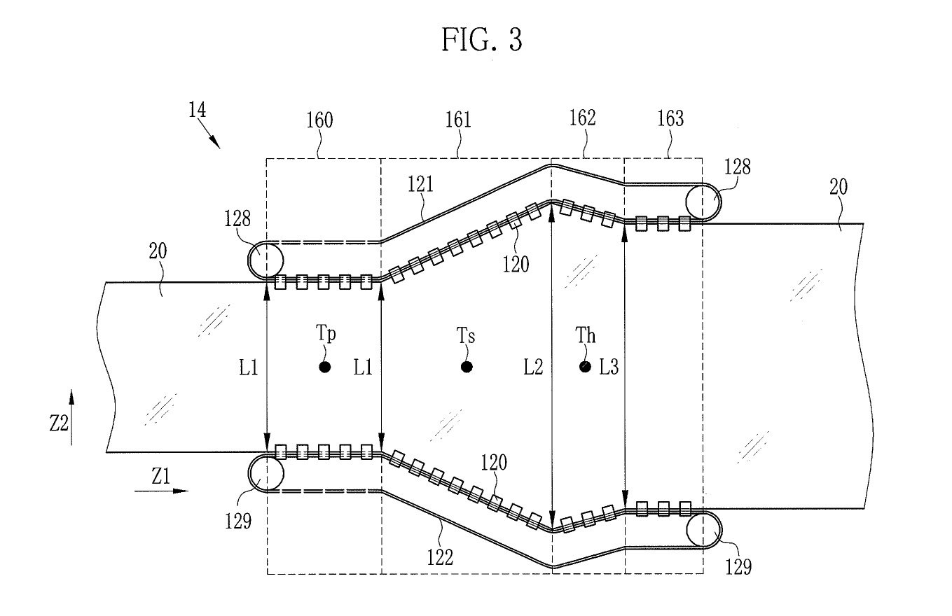

The clip tenter 14 is equipped with a plurality of clip 120 (see, FIG. 3) to hold the side ends of the film 20, and these clips 120 run with an endless chain that moves along a film-stretching path. The film 20 is stretched in the width direction and dried at the same time as it is held and conveyed by the clips 120 in the dry air applied to it. In this drying process, the residual solvent level is adjusted to not less than 0.03 wt. % and not greater than 10 wt. %. The film 20 thus dried undergoes a relaxation process to remove the remaining stress of stretching in the width direction. This series of stretching and relaxing processes in the clip tenter 14 serves to give a desired optical characteristic to the film 20.

An edge slitter 43 is placed downstream of each of the pin tenter 13 and the clip tenter 14. These edge slitters 43 cut off the side ends from the film. The severed edges are crushed in a crusher 44, and reused as a dope material or the like.

The drying chamber 15 has a plurality of rollers 47. The film 20 is hang around these rollers 47, and carried to dry gradually. The drying chamber 15 is connected to an adsorbing device 48 which adsorbs and recovers the solvent evaporated from the film 20.

A cooling chamber 16 is provided on an outlet side of the drying chamber 15. In this cooling chamber 16, the film 20 is cooled to room temperature. Provided downstream of the cooling chamber 16 is a compulsory neutralization device (neutralization bar) 49, which makes the film 20 electrically neutral. The neutralization bar 49 is connected to a knurling roller pair 50 that provides knurls to the side edge portions of the film 20. The winding chamber 17 houses a winding device 51 equipped with a press roller 52. The film 20 is wound into roll around a core of the winding device 51.

Next, the operation of the solution casting apparatus 10 is described. In the stock tank 11, the jacket 11c keeps the temperature of the dope 21 at between 25° C. and 30° C. Additionally, the stirring blade 11b keeps stirring the dope 21 to mix evenly. The gear pump 25 feeds the dope 21 from the stock tank 11 to the filtering device 26, which filters out impurities from the dope 21. This filtered dope 21 is then casted from the casting die 30 onto the casting drum 32 which is cooled down to a predetermined surface temperature, and a casting bead is formed thereon. It is preferred to keep the dope 21 at a substantially constant temperature between 30° C. and 35° C. during casting.

The casting drum 32 rotates about an axis 32a, and the surface of the drum 32 runs in the Z1 direction at a constant speed (for example, not slower than 30 m/min and not faster than 200 m/min). The surface of the casting drum 32 is adjusted to a substantially constant temperature between not less than −10° C. and not greater than +10° C. It is possible, by using the casting drum 32 cooled down in this manner, to solidify the cast film 33 until it shows the self-supporting property. Note that the surface temperature of the casting drum 32 is controlled by the temperature controller 36. As cooling of the cast film 33 progresses, a cross-linking point is formed as a base of crystal to accelerate the solidification of the cast film 33.

This gel-like cast film 33 with the self-supporting property is peeled off from the casting drum 32 with the peel roller 34. This peeled film is transferred, as the wet film 38, by the feed roller 42 to the pin tenter 13.

The casting chamber 12 is controlled to have a substantially constant interior temperature between 10° C. and 57° C. by the temperature controller 35. Inside the casting chamber 12, the solvent vapor from the cast dope 21 and the cast film 33 floats. In this embodiment, this floating solvent vapor is firstly condensed to liquefy by the condenser 39, and recovered in the recovery device 40, and then refined in the refining apparatus, and finally reused as dope adjusting solvent.

In the pin tenter 13, the wet film 38 is dried, while conveyed by the pin plate, into the film 20. The film 20, though still containing the solvent, is transferred to the clip tenter 14. At this point, just in front of the clip tenter 14, the residual solvent level of the film 20 is not less than 0.1 wt. % and not greater than 10 wt. %.

In the clip tenter 14, the film 20 is conveyed and dried out, while held at the side edge portions by the clips 120. With this drying process, most of the residual solvent is evaporated from the film 20, and the residual solvent level falls down to the range not less than 0.03 wt. % and not greater than 10 wt. %. Additionally, the clips 120 are arranged such that the distance between the confronting clips (the distance in the film width direction) is first increased gradually and then decreased gradually. This changing distance between the clips 120 serves to stretch the film 20 in the width direction, and then relaxes the remaining stretching stress of the film 20 in the width direction. This stretching and relaxing process in the width direction orients the molecules in the film 20, and gives a desired retardation to the film 20.

Out of the pin tenter 13 and the clip tenter 14, the film 20 reaches the edge slitter 43 where the side ends of the film 20 are cut off. The severed film 20 is conveyed through the drying chamber 15 and the cooling chamber 16, and wound by the winding device 51 in the winding chamber 17. The side ends cut off with the edge slitter 43 are crashed into pieces by the crusher 44, and reused as dope adjusting chips.

The film 20 thus wound by the winding device 51 preferably has a length of, at least, not less than 100 m in the longitudinal direction (conveyance direction). The width of the film 20 is preferably not less than 600 mm, and more preferably in the range not less than 1400 mm and not greater than 2500 mm. Nonetheless, the present invention is still effective to films wider than 2500 mm. Also, the present invention is applicable to manufacture of thin films with the thickness of not less than 20 μm and not greater than 80 μm.

[Film Stretching and Relaxing Method]

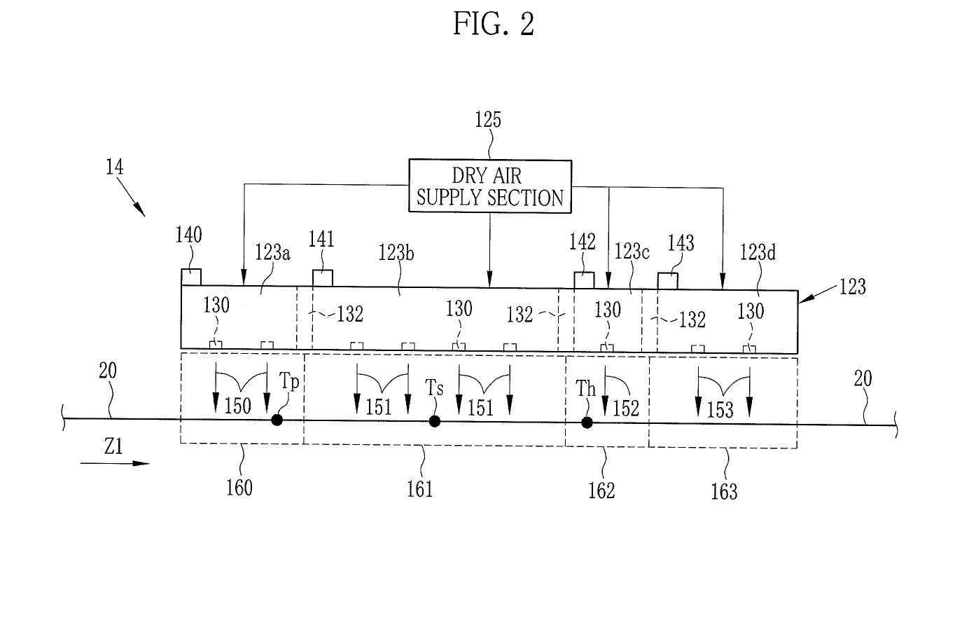

Next, the method for stretching and relaxing the film 20 in the clip tenter 14 is described. As shown in FIG. 2 and FIG. 3, the clip tenter 14 stretches the film 20 in a width direction Z2, and dries out the film 20 with dry air 150 to 153. The clip tenter 14 includes the clips 120, rails 121, 122, a dry air duct 123 and a dry air supply section 125. In FIG. 3, to avoid complicating the drawings, only a few clips are denoted by a numeral 120.

The clips 120 hold the both side ends of the film 20. The rails 121, 122 are placed on the opposite sides of the conveyer path for the film 20, apart from each other at a predetermined distance in the width direction of the film 20. The distance between the rails 121, 122 is determined to correspond to a stretch rate X and a relaxation rate Y for the film 20. The stretch rate X (%) is expressed by a formula (L2−L1)/L1×100, while the relaxation rate Y (%) is expressed by a formula (L3−L2)/L2×100, wherein L1 is the width of the film 20 immediately before stretching, L2 is the width of the film 20 immediately after stretching, and L3 is the width of the film 20 immediately after relaxing.

The clips 120 slide on the rails 121, 122. The clips 120 on the same rail are connected to each other with an endless chain (not shown). The chain for the rail 121 engages with a sprocket pair 128, and so the chain for the rail 122 does with a sprocket pair 129. As the sprocket pairs 128, 129 rotate, the clips 120 slide along the rail 121, 122. Seized by these sliding clips 120, the film 20 is moved in the Z1 direction to stretch or relax in the Z2 direction.

Above the conveyance path of the film 20 is disposed a dry air duct 123. On the bottom surface of the dry air duct 123, a plurality of slits 130 are elongated in the Z2 direction. These slits 130 are placed at certain intervals in the Z1 direction. Interior space of the dry air duct 123 is separated by partition plates 132 into first to fourth air supply chambers 123a-123c. In FIG. 3, to avoid complicating the drawings, only a few slits are denoted by a numeral 130. In this embodiment, an additional dry air duct may be provided beneath the conveyance path of the film 20.

The dry air supply section 125 supplies dry air to the first to fourth air supply chambers 123a-123c of the dry air duct 123. The dry air is cooled down or heated up to a predetermined temperature in each of the first to fourth air supply chambers 123a-123c. Dry air 150-153 in the first to fourth air supply chambers 123a-123c is blown off through the slits 130 to the film 20 under conveyance.

The clip tenter 14 is separated, along the Z1 direction, into a preheating area 160, a stretching area 161, a relaxing area 162 and a cooling area 163.

In the preheating area 160, the dry air 150 in the first air supply chamber 123a is blown off to the film 20. The dry air 150 changes a surface temperature Tp of the film 20, five seconds before entering the stretching area 161, to the range not less than 100° C. and not greater than 190° C. When Tp falls below 100° C., the film 20 may crack and is hardly manufactured stably. When Tp exceeds 190° C., on the other hand, the optical unevenness of the film 20 becomes more prominent.

In this preheating area 160, the rails 121, 122 are apart at a constant distance. Therefore, the film 20 is conveyed in the Z1 direction in the preheating area 160, while its width is kept to L1.

In the stretching area 161, the film 20 is stretched in the Z2 direction at the stretch rate X. The stretch rate X is preferably in the range not less than 0% and not greater than 100%, and more preferably not less than 5% and not greater than 80%, and yet more preferably not less than 10% and not greater than 70%. When the X exceeds 100%, the film 20 may crack and is hardly manufactured stably.

In this stretching area 161, the dry air 151 in the second air supply chamber 123b is blown off to the film 20. The dry air 151 changes a surface temperature Ts of the film 20, at a center position in the longitudinal direction of the stretching area 161, to the range not less than Tg (° C.) and not greater than 190° C. Here, Tg is a glass transition temperature of the film 20, and is preferably 140° C. Specifically, in this embodiment, Tg is the glass transition temperature of the film 20 at an entrance to the clip tenter 14. When Ts falls below Tg, the film 20 may crack and is hardly manufactured stably. When Ts exceeds 190° C., on the other hand, the optical unevenness of the film 20 becomes more prominent.

In the relaxing area 162, the width of the film 20 once stretched in the stretching area 161 is held or shrunk so as to remove the remaining stress of stretching. This process is referred to as a relaxation process. The relaxation rate Y is preferably in the range not less than 0% and not greater than 10%, and more preferably not less than 0% and not greater than 9%, and yet more preferably not less than 0% and not greater than 8%. When the Y exceeds 10%, the film 20 may have thickness variation and optical unevenness inconveniently.

In this relaxing area 162, the dry air 152 in the third air supply chamber 123c is blown off to the film 20. The dry air 152 changes a surface temperature Th of the film 20, five seconds after departing the stretching area 161, to the range not less than 50° C. and not greater than 190° C. When Th falls below 50° C., the optical axis variation of the film 20 is difficult to prevent. Here, the optical axis variation of the film 20, which is the variation of the optical axis in the width direction, is expressed as an angle of the optical axis to the direction perpendicular to the conveyance direction of the film 20 (i.e., the Z1 direction). The direction perpendicular to the Z1 is, namely, a surface normal direction to the film 20, and therefore it is hereinafter referred to as a “film normal direction”. When Th exceeds 190° C., on the other hand, the optical unevenness of the film 20 becomes more prominent.

In the cooling area 163, the dry air 153 in the fourth air supply chamber 123d is blown off to the film 20. The dry air 153 changes a surface temperature of the film 20 to a predetermined level.

In each of the areas 160-163 of the clip tenter 14, the maximum surface temperature Tmax (° C.) of the film 20 is kept at the range not less than Tg and not greater than 190° C. When Tmax falls below Tg, the film 20 may crack. When Tmax exceeds 190° C., on the other hand, the optical unevenness of the film 20 becomes more prominent.

In the clip tenter 14, to minimize the optical axis variation, the surface temperature Tp, Ts, Th of the film 20 and the relaxation rate Y are controlled to satisfy Expression 1 below.

6≦{(− 1/12)×Tp}+{(−⅕)×Ts}+{(⅓)×Th}+Y≦18 (Expression 1)

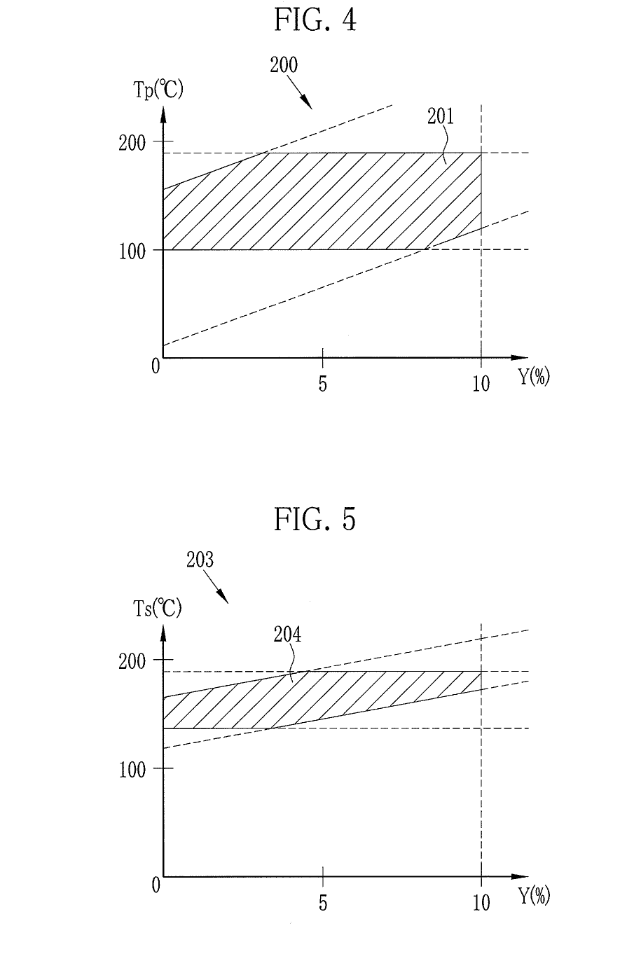

The variables Tp, Ts, Th and Y of Expression 1 are obtained though experiments. As shown in FIG. 4, a graph 200 depicts the relation between the surface temperature Tp (° C.) and the relaxation rate Y (%), wherein the surface temperature Ts and Th are fixed at 180° C. and 165° C. respectively. As is evident from the graph 200, when Y and Tp fall within an area 201, the optical axis variation of the film 20 is controlled within a ±5° range (favorably within a ±3° range, and yet favorably within a ±1.5° range) to the film normal direction. The area 201 is expressed by Expression 2 and Expression 3 below.

−13≦{(− 1/12)×Tp}+Y≦−1 (Expression 2)

100<Tp<190 (Expression 3)

As shown in FIG. 5, a graph 203 depicts the relation between the surface temperature Ts (° C.) and the relaxation rate Y (%), wherein the surface temperature Tp and Th are fixed at 160° C. and 165° C. respectively. As is evident from the graph 203, when Y and Ts fall within an area 204, the optical axis variation of the film 20 is controlled within a ±5° range (favorably within a ±3° range, and yet favorably within a ±1.5° range) to the film normal direction. The area 204 is expressed by Expression 4 and Expression 5 below.

−35.7≦{(−⅕)×Ts}+Y≦−23.7 (Expression 4)

Tg<Ts<190 (Expression 5)

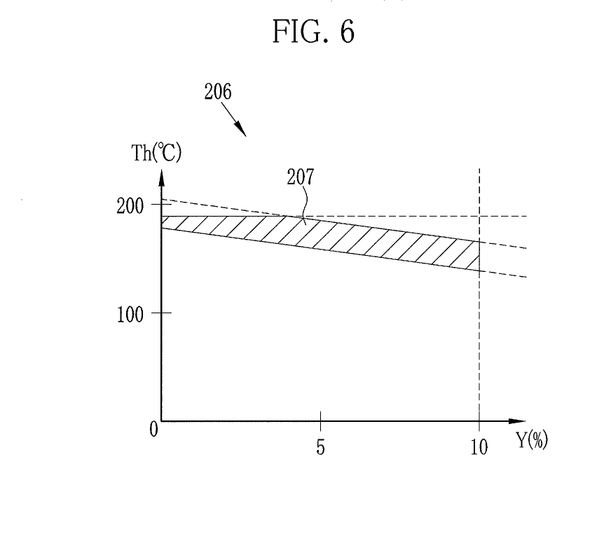

As shown in FIG. 6, a graph 206 depicts the relation between the surface temperature Th (° C.) and the relaxation rate Y (%), wherein the surface temperature Tp and Ts are fixed at 160° C. and 180° C. respectively. As is evident from the graph 206, when Y and Th fall within an area 207, the optical axis variation of the film 20 is controlled within a ±5° range (favorably within a ±3° range, and yet favorably within a ±1.5° range) to the film normal direction. The area 207 is expressed by Expression 6 and Expression 7 below.

55.3≦{(⅓)×Th}+Y≦67.3 (Expression 6)

50<Th<190 (Expression 7)

Based on the above Expressions 2-7, Expression 1 is calculated for the surface temperature Tp, Ts, Th of the film 20 and the relaxation rate Y.

By stretching and relaxing the film 20, the clip tenter 14 adjusts an in-plane retardation value (Re) within the range not less than 20 nm and not greater than 80 nm, and also adjusts a thickness-direction retardation value (Rth) within the range not less than 100 nm and not greater than 300 nm.

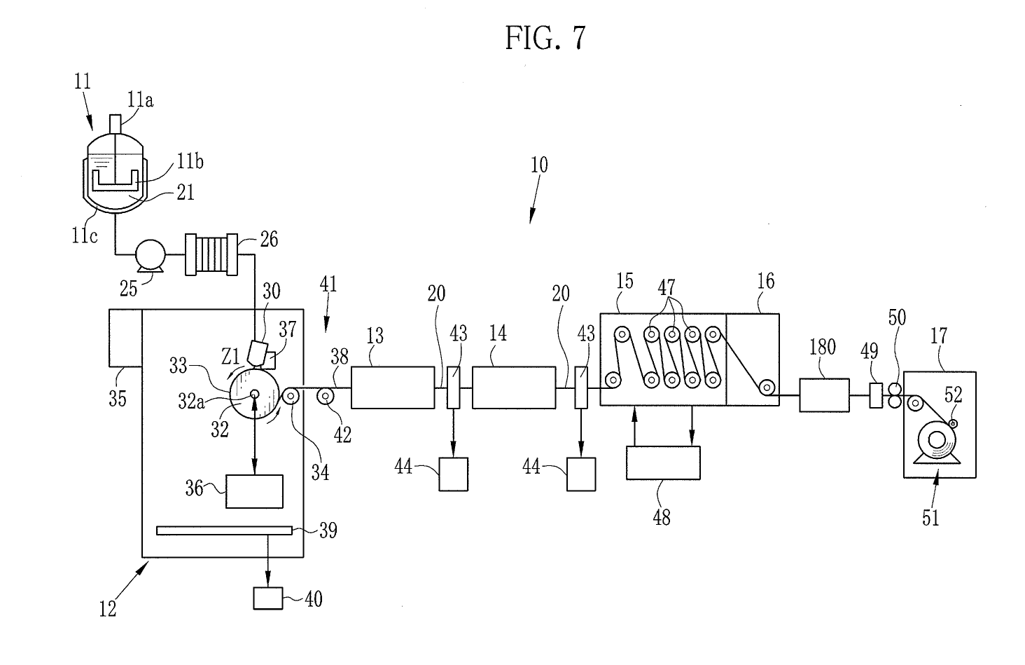

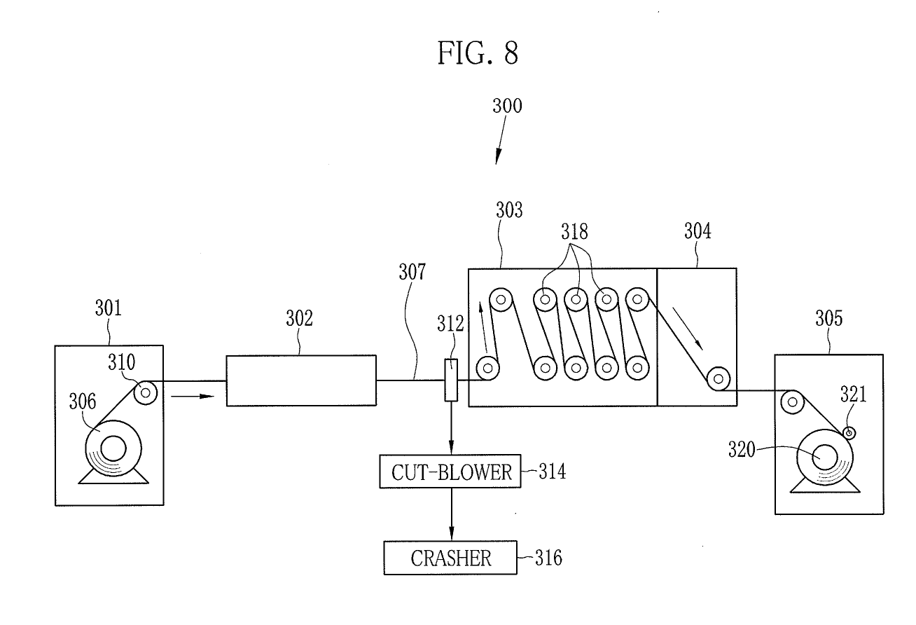

Although the film is stretched and relaxed in the clip tenter in the above embodiments, the present invention works well for stretching and relaxing the films on extremely low residual solvent level (for example, not greater than 10 wt. %). If the residual solvent level has been reduced to 10 wt. % or less before the film enters the pin tenter, the present invention can be implemented in the pin tenter. Furthermore, as shown in FIG. 7, a tenter 180 that has the same configuration as the clip tenter 14 to implement the present invention may be provided between the cooling chamber 16 and the winding chamber 17. Additionally or alternatively, as shown in FIG. 8, the present invention may be implemented in an off-line stretching apparatus 300 which stretches and relaxes the produced films.

The off-line stretching apparatus 300 includes a supply section 301, a tenter section 302, a drying section 303, a cooling section 304 and a winding section 305. The supply section 301 contains a roll 306 of the film 20 which is produced by the solution casting apparatus 10 of FIG. 1. The film 20 is conveyed by a supply roller 310 to the tenter section 302.

The tenter section 302 has the same configuration as the clip tenter 14 shown in FIG. 2 and FIG. 3. The tenter section 302 performs the same stretching and relaxing process as the above embodiment, and produces a film 307 whose optical axis variation is regulated to a range of ±5° to the film surface.

Between the tenter section 302 and the drying section 303 is provided an edge slitter 312 to cut off the side ends of the film 307. The severed edges are cut into small pieces by a cut-blower 314. These pieces of the edges are put into a crusher 316, and crushed into chips.

The drying section 303 has a plurality of rollers 318 to convey the film 307 to the cooling section 304. In the drying section 303, dry air is blown off to the film 307 in conveyance. Then, in the cooling section 304, the film 307 is cooled to a predetermined temperature. The cooled film 307 is feed to the winding section 305 equipped with a winding roller 320 and a press roller 321. The film 307 is wound, while pressed by the press roller 321, into a roll around the winding roller 320.

Next, the material for the dope 21 is described.

In the above embodiments, the polymer is cellulose acylate. A particularly suitable cellulose acylate is cellulose triacetate (TAC). Preferably, the cellulose acylate satisfies the following Expressions (I)-(III) for a degree of acyl substitution for hydroxyl groups in cellulose:

2.5≦A+B≦3.0 (I)

0≦A≦3.0 (II)

0≦B≦2.9 (III)

wherein A+B is a degree of substitution of acyl groups for hydrogen atoms on hydroxyl groups of cellulose, and A is a degree of substitution of acetyl groups, and B is a degree of substitution of acyl groups having 3 to 22 carbon atoms. It is preferred that 0.1-4 mm particles make up 90 wt. % or more of TAC. The polymer, however, is not limited to cellulose acylate in the present invention.

Glucose unit in beta-1,4 linkage of cellulose have free hydroxyl groups at 2, 3 and 6 positions. Cellulose acylate is a polymer in which a part or all of the hydroxyl group is esterified with the acyl group having carbon number of 2 or above. The degree of substitution of acyl groups indicates the percentage of the esterified hydroxyl groups of cellulose at 2, 3 and 6 positions (as the degree 1 is 100% esterification).

A total acylation degree, or a value of DS2+DS3+DS6 is preferably between 2.00 and 3.00, and more preferably between 2.22 and 2.90, and yet more preferably between 2.40 and 2.88. Additionally, a value of DS6/(DS2+DS3+DS6) is preferably 0.28, and more preferably 0.30 or above, and yet more preferably between 0.31 and 0.34. Here, DS2 is a percentage of acyl substitution for hydrogen atoms on the 2-position hydroxyl groups in the glucose unit (hereinafter, 2-position acyl substitution degree), while DS3 is a percentage of acyl substitution for hydrogen atoms on the 3-position hydroxyl groups in the glucose unit (hereinafter, 3-position acyl substitution degree), and DS6 is a percentage of acyl substitution for hydrogen atoms on the 6-position hydroxyl groups in the glucose unit (hereinafter, 6-position acyl substitution degree).

The cellulose acylate for the present invention can contain one kind, or two or more kinds of acyl groups. If two or more kinds of acyl groups are to be contained, one of them is preferably an acetyl group. A value of DSA+DSB is preferably between 2.22 to 2.90, and more preferably between 2.40 to 2.88, where DSA is a sum of the degree of acetyl substitution for the hydroxyl groups at 2, 3 and 6 positions, and DSB is a sum of the degree of substitution of acyl groups except the acetyl group for the hydroxyl groups at 2, 3 and 6 positions.

DSB is preferably 0.30 or above, and more preferably 0.7 or above. Additionally, a substituent group of the 6-position hydroxyl group makes up 20% or above of DSB preferably, and 25% or above more preferably, and 30% or above yet more preferably, and 33% or above most preferably. Furthermore, the value of DSA+DSB at the 6 position is preferably 0.75 or above, and more preferably 0.80 or above, and yet more preferably 0.85 or above. This type of cellulose acylate produces a dope with better solubility. Especially, when used with non-chlorine organic solvent, the resultant dope will offer excellent solubility, low-viscosity and excellent filtering performance.

Cellulose as a material for cellulose acylate may be obtained from either linter or pulp.

For the cellulose acylate in the present invention, the acyl group having carbon number of 2 or above can be, but not limited to, an aliphatic group or an aryl group, such as alkyl carbonyl ester, alkenyl carbonyl ester, aromatic carbonyl ester and aromatic alkyl carbonyl ester of cellulose. It raises no object whether a further substituted group is contained or not. For example, a propionyl group, a butanoyl group, a pentanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexane carbonyl group, an oleoyl group, a benzoyl group, a naphthyl carbonyl group and a cinnamoyl group are preferred. Particularly preferred among these are the propionyl group, the butanoyl group, the dodecanoyl group, the octadecanoyl group, the t-butanoyl group, the oleoyl group, the benzoyl group, the naphthyl carbonyl group and the cinnamoyl group. Most preferable among these are the propionyl group and the butanoyl group.

The solvent for the dope may be aromatic hydrocarbon (such as, benzene, toluene), halogenated hydrocarbon (such as, dichloromethane, chlorobenzene), alcohol (such as, methanol, ethanol, n-propanol, n-butanol, diethylene glycol), ketone (such as, acetone, methyl ethyl ketone), ester (such as, methyl acetate, ethyl acetate, propyl acetate) and ether (such as, tetrahydrofuran, methyl cellosolve).

The halogenated hydrocarbon having carbon number of 1 to 7 is favorably used, and the dichloromethane is most favorably used. From a standpoint of physical properties, such as TAC solubility, ease in peel-off of the cast film from the support member, mechanical strength and optical character of the film, it is preferred to use one or a few kinds of alcohol having carbon number of 1 to 5, together with the dichloromethane. Alcohol content to the whole liquid solution is preferably between 2 wt. % and 25 wt. %, and more preferably between 5 wt. % and 20 wt. %. Favorable alcohol is methanol, ethanol, n-propanol, isopropanol and n-butanol, but especially preferred is methanol, ethanol, n-butanol and the mixture of these.

Meanwhile, to minimize environmental impact, dichloromethane-free solvent is proposed recently. If this is the case, preferable alternative may be ether having carbon number of 4 to 12, ketone having carbon number of 3 to 12, ester having carbon number of 3 to 12, alcohol having carbon number of 1 to 12, and possibly the mixture of these, such as the mixed solvent of methyl acetate, acetone, ethanol and n-butanol. These ether, ketone, ester and alcohol can have a ring structure. Furthermore, the solvent may be composed of a compound having two or more functional groups (namely, —O—, —CO—, —COO— and —OH) of ether, ketone, ester or alcohol.

Cellulose acylate is described in detail in Japanese Patent Laid-open Publication No. 2005-104148, paragraphs [0140] to [0195], and these descriptions can be utilized in the present invention. This Publication No. 2005-104148 also describes the solvent and various additives, such as plasticizer, deterioration inhibitor, ultraviolet absorbing agent (UV agent), optical anisotropy controller, retardation controller, dye, matting agent, remover and release accelerator, in paragraphs [0196] to [0516], and these descriptions can be utilized in the present invention.

With the solution casting method according to the present invention, it is possible to cast two or more different kinds of dope simulteneously to form a layer (hereinafter, simultaneous co-casting technique) or to cast different kinds of dope sequentially to form a layer (hereinafter, sequential co-casting technique). Furthermore, these co-casting techniques can be combined. For the simultaneous co-casting technique, a casting die with a feed block or a multi-manifold die may be used. It should, however, be better to control at least one of the upper-most layer and the support-member side layer to have the thickness making up 0.5% to 30% of the whole thickness of this multi-layer film produced by the co-casting technique. Additionally, in the simultaneous co-casting technique, it is preferred that low-viscosity dope wraps around high-viscosity dope throughout the passage from the die slit to the support member, and that the dope to the atmospheric air has higher alcohol proportion than the inner dopes of a casting bead formed between the die slit and the support member.

Various conditions and methods, from the structures of the casting die, the decompression chamber and the support member, the co-casting technique, the peeling method, the stretching method, drying condition in each process, a film-handling method, curling, the winding method after flatness correction, up to the solvent recovery method and the film recovery method are described in detail in the Publication No. 2005-104148, paragraphs [0617] to [0889], and these descriptions can be utilized in the present invention.

Hereafter, the film stretching and relaxing method according to the present invention is described specifically with Examples 1 to 6 and Comparative examples 1 to 6. Examples 1 to 6 and Comparative examples 1 to 6 were implemented by the clip tenter 14 shown in FIG. 2 and FIG. 3, with changing the conditions. In each example, the glass transition temperature Tg of the film 20 was 140° C.

### EXAMPLE 1

The film 20 was produced at the stretch rate X of 50% and the relaxation rate Y of 4%. The surface temperature Tp of the film 20 five seconds before entering the stretching area 161 was adjusted to 130° C., while the surface temperature Ts of the film 20 at a center position in the longitudinal direction of the stretching area 161 was adjusted to 180° C., and the surface temperature Th of the film 20 five seconds after departing the stretching area 161 was adjusted to 170° C. The maximum surface temperature Tmax of the film 20 in the clip tenter 14 was kept at 180° C. Based on the expression to control the optical axis variation, {(− 1/12)×Tp}+{(−⅕)×Ts}+{(⅓)×Th}+Y, the calculated value of the resultant film (hereinafter, axis variation control value) was 13.833.

### EXAMPLE 2

The film 20 was produced at the stretch rate X of 50% and the relaxation rate Y of 0%. The surface temperature Tp was adjusted to 132° C., while the surface temperature Ts was adjusted to 180° C., and the surface temperature Th was adjusted to 180° C. The maximum surface temperature Tmax was kept at 183° C. The axis variation control value was 13.

### EXAMPLE 3

The film 20 was produced at the stretch rate X of 50% and the relaxation rate Y of 4%. The surface temperature Tp was adjusted to 186° C., while the surface temperature Ts was adjusted to 180° C., and the surface temperature Th was adjusted to 189° C. The maximum surface temperature Tmax was kept at 189° C. The axis variation control value was 15.5.

### EXAMPLE 4

The film 20 was produced at the stretch rate X of 50% and the relaxation rate Y of 9%. The surface temperature Tp was adjusted to 110° C., while the surface temperature Ts was adjusted to 180° C., and the surface temperature Th was adjusted to 135° C. The maximum surface temperature Tmax was kept at 180° C. The axis variation control value was 8.8333.

### EXAMPLE 5

The film 20 was produced at the stretch rate X of 25% and the relaxation rate Y of 4%. The surface temperature Tp was adjusted to 135° C., while the surface temperature Ts was adjusted to 180° C., and the surface temperature Th was adjusted to 165° C. The maximum surface temperature Tmax was kept at 180° C. The axis variation control value was 11.75.

### EXAMPLE 6

The film 20 was produced at the stretch rate X of 25% and the relaxation rate Y of 4%. The surface temperature Tp was adjusted to 135° C., while the surface temperature Ts was adjusted to 150° C., and the surface temperature Th was adjusted to 150° C. The maximum surface temperature Tmax was kept at 150° C. The axis variation control value was 12.75.

### COMPARATIVE EXAMPLE 1

The film 20 was produced at the stretch rate X of 50% and the relaxation rate Y of 12%. The surface temperature Tp was adjusted to 180° C., while the surface temperature Ts was adjusted to 180° C., and the surface temperature Th was adjusted to 160° C. The maximum surface temperature Tmax was kept at 180° C. The axis variation control value was 14.333.

### COMPARATIVE EXAMPLE 2

The film 20 was produced at the stretch rate X of 50% and the relaxation rate Y of 4%. The surface temperature Tp was adjusted to 90° C., while the surface temperature Ts was adjusted to 180° C., and the surface temperature Th was adjusted to 160° C. The maximum surface temperature Tmax was kept at 180° C. The axis variation control value was 13.833.

### COMPARATIVE EXAMPLE 3

The film 20 was produced at the stretch rate X of 20% and the relaxation rate Y of 4%. The surface temperature Tp was adjusted to 130° C., while the surface temperature Ts was adjusted to 130° C., and the surface temperature Th was adjusted to 145° C. The maximum surface temperature Tmax was kept at 145° C. The axis variation control value was 15.5.

### COMPARATIVE EXAMPLE 4

The film 20 was produced at the stretch rate X of 50% and the relaxation rate Y of 4%. The surface temperature Tp was adjusted to 195° C., while the surface temperature Ts was adjusted to 205° C., and the surface temperature Th was adjusted to 200° C. The maximum surface temperature Tmax was kept at 205° C. The axis variation control value was 13.417.

### COMPARATIVE EXAMPLE 5

The film 20 was produced at the stretch rate X of 50% and the relaxation rate Y of 4%. The surface temperature Tp was adjusted to 160° C., while the surface temperature Ts was adjusted to 180° C., and the surface temperature Th was adjusted to 130° C. The maximum surface temperature Tmax was kept at 180° C. The axis variation control value was −2.

### COMPARATIVE EXAMPLE 6

The film 20 was produced at the stretch rate X of 50% and the relaxation rate Y of 4%. The surface temperature Tp was adjusted to 110° C., while the surface temperature Ts was adjusted to 180° C., and the surface temperature Th was adjusted to 185° C. The maximum surface temperature Tmax was kept at 185° C. The axis variation control value was 20.5.

In the above Examples 1-6 and Comparative examples 1-6, the resultant film 20 was measured in the following manner to evaluate the retardation value and the degree of the optical axis variation. Additionally, the visual inspection was performed to evaluate the optical unevenness of the film 20.

[Retardation Measurement]

The in-plane retardation Re (λ) was measured with KOBRA-21ADH (Oji Scientific Instruments) while radiating a beam at λnm wavelength on the film 20 from the surface normal direction of the film. The thickness-direction retardation Rth (λ) was calculated with KOBRA-21ADH using the value of the in-plane retardation Re (λ), and a first retardation and a second retardation values. The first retardation value was measured with radiating the λnm wavelength beam from a direction inclined at +40° to the surface normal of the film 20 which is rotated about its in-plane slow axis (measured with KOBRA-21ADH), while the second retardation value was measured with radiating the λnm wavelength beam from a direction inclined at −40° to the surface normal of the film 20 which is rotated about its in-plane slow axis. Here, it is possible to use an average refractive index value described in “Polymer Handbook” (John Wiley & Sons, Inc), or shown in the catalogues of various optical films. The average refractive index value, if unknown, can be measured with an abbe refractometer. A typical average refractive index value of each chemical is cellulose acylate (1.48), cycloolefin polymer (1.52), polycarbonate (1.59), polymethyl methacrylate (1.49) and polystyrene (1.59). When an average refractive index value and a film thickness are entered, KOBRA-21ADH calculates nx, ny and nz. Nz factor is then calculated, when necessary, by an expression Nz=(nx−nz)/(nx−ny) using the calculated nx, ny and nz.

[Optical Axis Variation Measurement]

The optical axis variation of the resultant film 20 was measured with an automatic birefringence meter (KOBRA-21DH, Oji Scientific Instruments). The optical axis was measured at 20 points equally spaced from each other across the entire width of the film, and the average absolute value thereof was calculated. Additionally, using the absolute values of these 20 points, the differences in the four higher absolute values and the four lower absolute values were calculated to specify the range of a slow axis angle (optical axis variation).

[Results of Examples and Comparative Examples]

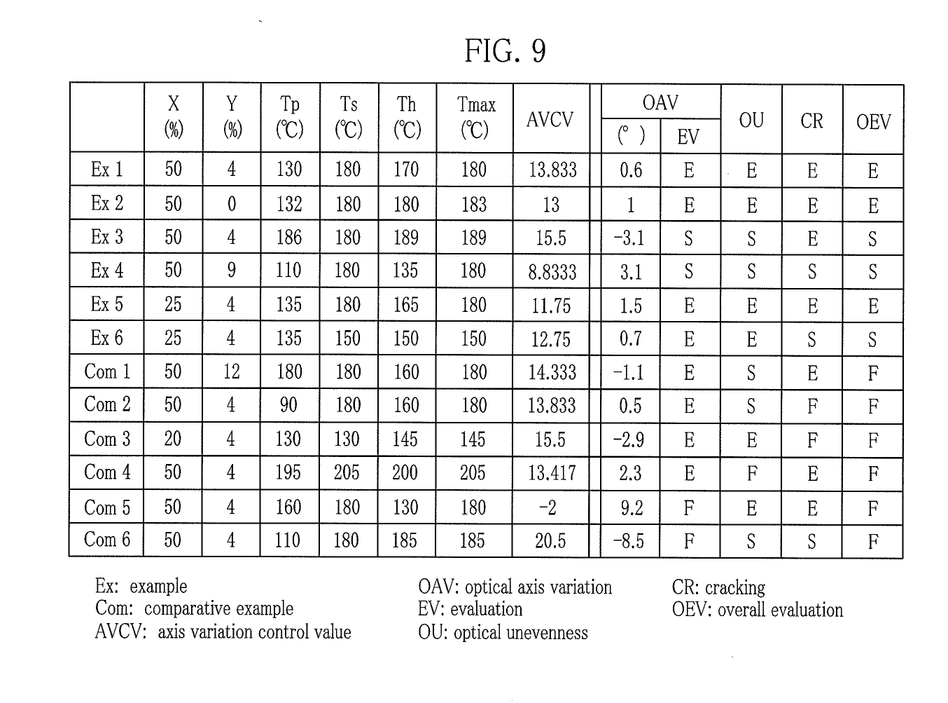

The results of the above Examples 1-6 and Comparative examples 1-6 are shown in table of FIG. 9. As for the retardation value, all the film of the examples showed the in-plane retardation Re of not less than 20 nm and not greater than 80 nm, and the thickness-direction retardation Rth of not less than 100 nm and not greater than 300 nm.

In the table, the evaluation for some items is expressed by a letter “E (excellent)”, “S (satisfactory)” or “F (failure)”. With regard to the item “optical axis variation”, “E” indicates that the optical axis variation resides within a ±3° range (except +3° and −3°) to the surface normal of the film 20. “S” indicates the optical axis variation within a ±5° range (except +5° and −5°) to the surface normal, and “F” indicates the optical axis variation outside the ±5° range to the surface normal.

With regard to the item “optical unevenness”, “E” indicates that no optical unevenness was seen on the film 20. “S” indicates that the optical unevenness was slightly seen, but did not pose a practical issue. “F” indicates that the optical unevenness was as bad as a conventional level unsuitable for high-luminance display devices. With regard to the item “cracking”, “E” indicates that the film did not crack during fabrication. “S” indicates that the film did not crack but looked ready to crack, and “F” indicates that the film cracked during fabrication.

The “overall evaluation” is determined based on the evaluations for the “optical axis variation”, the “optical unevenness” and the “cracking”. For the “overall evaluation”, “E” indicates that the film has an excellent optical property and is suitable for high-luminance display devices. “S” indicates that the film has a little problem with the optical property, but can be used in high-luminance display devices. “F” indicates that the film has a considerable problem with the optical property and is not suitable for high-luminance display devices.

As is evident by comparison of Examples 1-6 and Comparative examples 1-4 with Comparative examples 5 and 6, the optical axis variation was regulated within the ±5° range to the surface normal of the film 20 by controlling the surface temperatures Tp, Ts, Th, and the relaxation rate Y to achieve the axis variation control value of not less than 6 and not greater than 18. As is also evident by comparison of Example 3 with Comparative example 4, the optical unevenness was kept to a minor level by keeping the maximum surface temperature Tmax below 190° C. As is evident by comparison of Examples 1-6 and Comparative examples 1, 4-6 with Comparative examples 2 and 3, cracking of the film was prevented by adjusting the surface temperature Ts to the glass transition temperature Tg (140° C.) or above.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A film stretching and relaxing method for stretching a cellulose ester film, whose residual solvent level is not less than 0.03 weight percent and not greater than 10 weight percent, in a width direction of said film and subsequently relaxing said cellulose ester film in said width direction, with using a tenter having a preheating area, a stretching area and a relaxing area, said method comprising steps of:
keeping the maximum temperature Tmax (° C.) of said cellulose ester film at Tg≦Tmax≦190 in said tenter, wherein said Tg is a glass transition temperature (° C.) of said cellulose ester film;
keeping a temperature Tp (° C.) of said cellulose ester film in said preheating area at 100≦Tp≦190;
keeping a temperature Ts (° C.) of said cellulose ester film at the halfway point in a film conveyance direction of said stretching area at Tg≦Ts≦190;
stretching said cellulose ester film, in said stretching area, in said width direction at a stretch rate X (%) of 0<X≦100, wherein said stretch rate X is expressed by a formula (L2−L1)/L1, where L1 is a width of said cellulose ester film immediately before said stretching, and L2 is a width of said cellulose ester film immediately after said stretching;
keeping a temperature Th (C) of said cellulose ester film in said relaxing area at 50≦Th≦190;
relaxing said cellulose ester film, in said relaxing area, in said width direction at a relaxation rate Y (%) of 0≦Y≦10, wherein said relaxation rate Y is expressed by a formula (L3−L2)/L2, where L3 is a width of said cellulose ester film immediately after said relaxing; and
controlling said Tp, Ts, Th and Y to satisfy an expression as follow:
6≦{(− 1/12)×Tp}+{(−⅕)×Ts}+{(⅓)×Th}+Y≦18.

2. The film stretching and relaxing method of claim 1, wherein optical axis variation in said width direction of said cellulose ester film is adjusted within plus/minus 5 degrees to a line perpendicular to a surface of said cellulose ester film.

3. A solution casting method comprising said film stretching and relaxing method as described in claim 1, and for producing a cellulose ester film.
